(19) United States
(12) Patent Application Publication
(10) Pub. No.: US 2025/0306897 A1
(43) Pub. Date: Oct. 2, 2025

(54) PROGRAM UPDATE SYSTEM AND DISPLAY CONTROL METHOD

(71) Applicant: HONDA MOTOR CO., LTD., Tokyo (JP)

(72) Inventors: Takashi Tsujioka, Tokyo (JP); Takayoshi Nakamura, Tokyo (JP)

(21) Appl. No.: 19/020,195

(22) Filed: Jan. 14, 2025

(30) Foreign Application Priority Data
Mar. 26, 2024 (JP) 2024-048997

(51) Int. Cl. G06F 8/65; B60K 35/28; B60K 35/90; B60N 2/00; B60W 50/02; B60W 50/14

(52) U.S. Cl. CPC G06F 8/65; B60K 35/28; B60K 35/90; B60N 2/0025; B60W 50/0205; B60W 50/14; B60K 2360/56; B60K 2360/592; B60W 2050/146; B60W 2540/01; B60W 2556/45

(57) ABSTRACT

A program update system includes a server device, a central ECU installed in a vehicle, and a terminal device carried by an occupant of the vehicle, wherein the server device is configured to obtain state information indicating the state of a starter switch that starts the vehicle from the vehicle, and send announcement information inquiring whether or not to permit updating to an update program to one of the central ECU and the terminal device based on the state information, the central ECU is configured to display the announcement information on a touch panel provided in the vehicle if the central ECU receives the announcement information, and the terminal device is configured to display the announcement information on the touch panel of the terminal device if the terminal device receives the announcement information.

### INCORPORATION BY REFERENCE

The present application claims priority under 35 U.S.C. § 119 to Japanese Patent Application No. 2024-048997 filed on Mar. 26, 2024. The content of the application is incorporated herein by reference in its entirety.

### BACKGROUND OF THE INVENTION

### Field of the Invention

The present invention relates to a program update system and a display control method.

### Description of the Related Art

Conventionally, a program rewriting system has been proposed for updating a program for a computer installed in a vehicle (see, for example, Japanese Patent Laid-Open No. 2020-181252).

If a program update announcement is displayed on both an on-board display device of a vehicle and a terminal device carried by an occupant of the vehicle in order to obtain permission to perform a program update, operations may be accepted by both the terminal device and an update control device. In this case, different information may be input to a server device from the terminal device and the update control device, and to deal with such a situation, the process executed by the server device needs to be more sophisticated, which may increase the cost for the server device.

The purpose of this application is to improve safety by preventing the input of multiple different instructions to the server device in order to solve the above problem. Moreover, it can thereby offer further improvement of traffic safety and contribute to the sustainable development of the transportation system.

### SUMMARY OF THE INVENTION

As a first aspect to achieve the aforementioned object, a program update system is provided, which includes: a server device configured to provide an update program to be executed by an electronic control device installed in a vehicle; an update control device installed in the vehicle and configured to cause a program executed by the electronic control device to be updated to the update program; and a terminal device carried by an occupant of the vehicle, wherein the server device is configured to be able to send announcement information inquiring whether or not to permit updating to the update program to the update control device and the terminal device, and to obtain state information indicating a state of a starter switch that starts the vehicle from the vehicle and to send the announcement information to one of the update control device and the terminal device based on the state information, the update control device is configured to display the announcement information on an on-board display device provided in the vehicle if the update control device receives the announcement information, and the terminal device is configured to display the announcement information on a display unit of the terminal device if the terminal device receives the announcement information.

In the above program update system, the update control device may be configured to send the state information indicating that the starter switch is on to the server device when the starter switch is turned on, and the server device may be configured to send the announcement information to the update control device but not to the terminal device when the server device receives the state information.

In the above program update system, the vehicle may include an occupant detection device to detect the occupant getting in the vehicle, and the update control device may be configured to prohibit transmission of version information of the program installed in the electronic control device to the server device when the occupant detection device detects the occupant getting in the vehicle.

In the above program update system, if the on-board display device is in a predetermined state, the update control device may be configured to send a notification to the server device that the on-board display device is unable to display the announcement information, and when the server device receives the notification, the server device may be configured to send the announcement information to the terminal device even when the starter switch is on.

In the above program update system, the update control device may include a usage detection unit to detect usage of the on-board display device, and the predetermined state may include a state in which usage of the on-board display device is detected by the usage detection unit.

In the above program update system, the update control device may include a failure detection unit to detect a failure of the on-board display device, and the predetermined state may include a state in which a failure of the on-board display device is detected by the failure detection unit.

In the above program update system, if the update control device is unable to receive an operation indicating whether or not to permit updating to the update program before an end of display of the announcement information displayed on the on-board display device, the update control device may be configured to send a notification to the server device that the update control device has failed to receive the operation indicating whether or not to permit updating.

In the above program update system, the update control device may be configured to send the state information indicating that the starter switch is off to the server device when the starter switch is turned off, and the server device may be configured to send the announcement information to the terminal device when the server device receives the state information indicating that the starter switch is off.

In the above program update system, the server device may be configured to send the announcement information to the update control device if the server device is unable to send the announcement information to the terminal device.

The vehicle may include an occupant detection device to detect the occupant getting in the vehicle, and the update control device may be configured to continue to display the announcement information on the on-board display device if the starter switch is turned off but the occupant detection device determines that the occupant stays in the vehicle.

As a second aspect to achieve the aforementioned object, a display control method in a program update system is provided, the program update system including a server device configured to provide an update program to be executed by an electronic control device installed in a vehicle, an update control device installed in the vehicle and configured to cause a program executed by the electronic control device to be updated to the update program, and a terminal device carried by an occupant of the vehicle, the method including the server device being configured to be able to send announcement information inquiring whether or not to permit updating to the update program to the update control device and the terminal device, obtaining state information indicating a state of a starter switch that starts the vehicle from the vehicle, and sending the announcement information to one of the update control device and the terminal device based on the state information; the update control device displaying the announcement information on an on-board display device provided in the vehicle if the update control device receives the announcement information; and the terminal device displaying the announcement information on a display unit of the terminal device if the terminal device receives the announcement information.

### Advantageous Effect of Invention

The program update system and the display control method described above can prevent multiple different instructions from being input to a server device to increase efficiency of the process associated with program updates and improve safety.

### BRIEF DESCRIPTION OF THE DRAWINGS

FIG. 1 is a diagram illustrating a system configuration of a program update system;

FIG. 2 is a block diagram illustrating a configuration of a server device;

FIG. 3 is a diagram illustrating an example configuration of a user management DB;

FIG. 4 is a diagram illustrating an example configuration of a program management DB;

FIG. 5 is a diagram illustrating an example configuration of a vehicle state management DB;

FIG. 6 is a diagram illustrating an example configuration of a vehicle control system;

FIG. 7 is a diagram illustrating a configuration of a central ECU;

FIG. 8 is a diagram illustrating a configuration of a terminal device;

FIG. 9 is a flowchart illustrating an operation of the server device;

FIG. 10 is a flowchart illustrating an operation of the central ECU; and

FIG. 11 is a flowchart illustrating the operation of the central ECU.

### DETAILED DESCRIPTION OF THE INVENTION

### [1. Configuration of Program Update System]

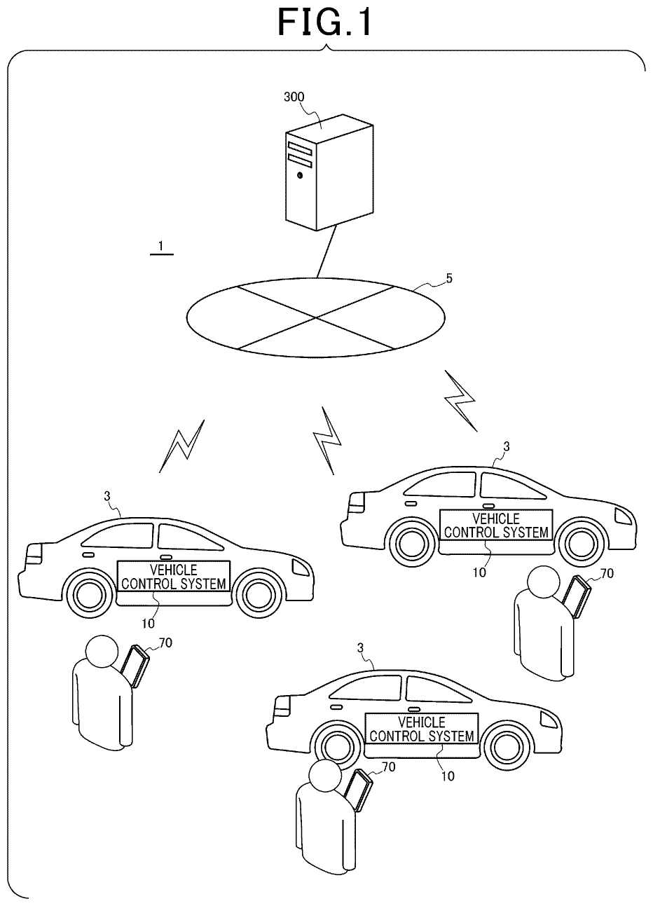

An embodiment of a program update method and a display control method is now described with reference to the drawings. FIG. 1 is a diagram illustrating a system configuration of a program update system 1.

The program update system 1 is a system in which a vehicle control system 10 installed in each of a plurality of vehicles 3, a terminal device 70 carried by an occupant of each of the vehicles 3, and a server device 300 are connected via a communication network 5. The communication network 5 includes, for example, a Local Area Network (LAN), a Wide Area Network (WAN), the Internet, and a mobile communication network such as a mobile phone network.

Update programs are registered with the server device 300 for updating programs executed by electronic control devices included in the vehicle control system 10 of each vehicle 3. The server device 300 causes the electronic control devices to download the registered update programs and update the programs executed by the electronic control devices.

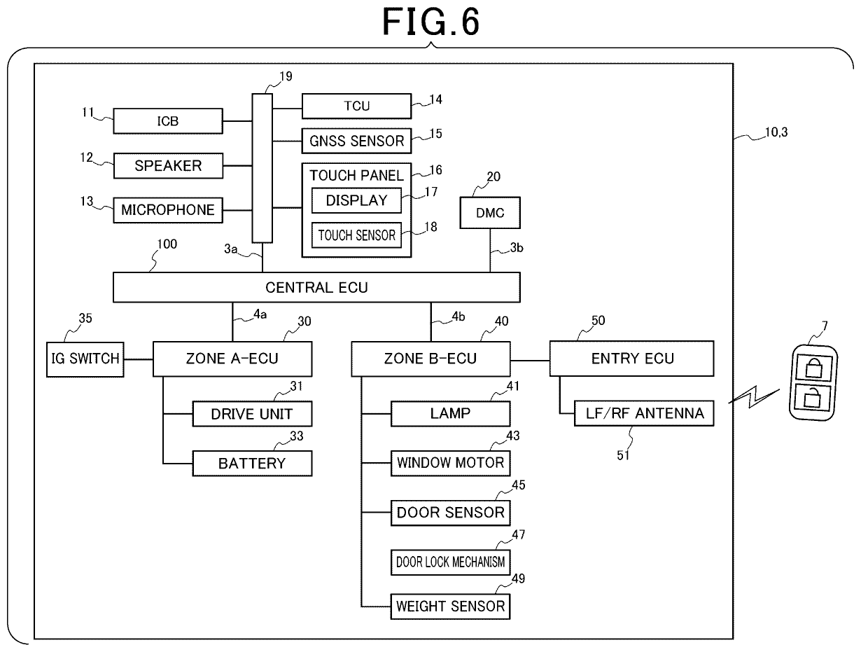

The vehicle control system 10 is a system in which a central Electronic Control Unit (ECU) 100 (see FIG. 6), which is an electronic control device functioning as a central gateway, and a plurality of electronic control devices are connected to each other so as to enable data communication between them. The plurality of electronic control devices are electronic control devices for which program rewriting is to be performed.

The terminal device 70 is a device carried by a user registered as a user with the server device 300, for example, a smartphone or a personal computer such as a tablet computer or a notebook computer.

### [2. Configuration of Server Device]

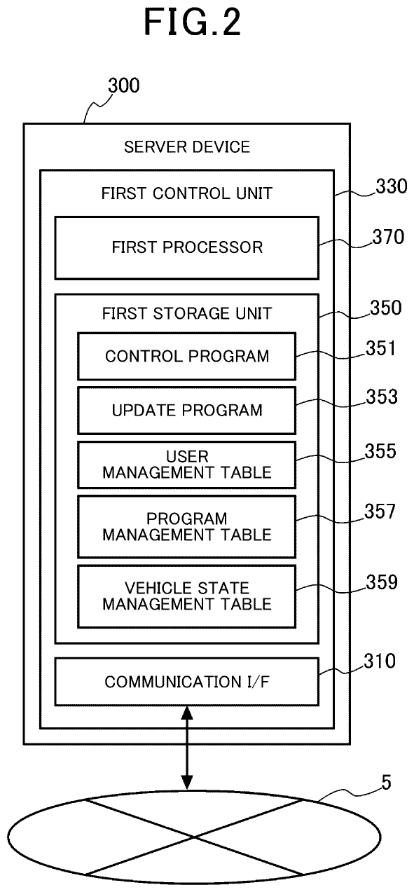

FIG. 2 is a block diagram illustrating a configuration of the server device 300.

The server device 300 includes a communication I/F 310 and a first control unit 330.

The communication I/F 310 includes a communication card, for example, a Network Interface Card (NIC), having a transmitter and receiver and performs mutual data communication with vehicle control systems 10 and the terminal devices 70 via the communication network 5.

The first control unit 330 is a computer device including a first storage unit 350 and a first processor 370.

The first storage unit 350 includes a semiconductor memory such as a Random Access Memory (RAM) or a Read Only Memory (ROM). The first storage unit 350 also includes a secondary storage device such as a Solid State Drive (SSD) or a Hard Disk Drive (HDD).

The first storage unit 350 stores a control program 351, update programs 353, a user management table 355, a program management table 357, and a vehicle state management table 359.

The control program 351 is a program executed by the first processor 370.

The update programs 353 are programs provided to the vehicle control systems 10. That is, the update programs 353 are update programs for programs executed by electronic control devices constituting each vehicle control system 10.

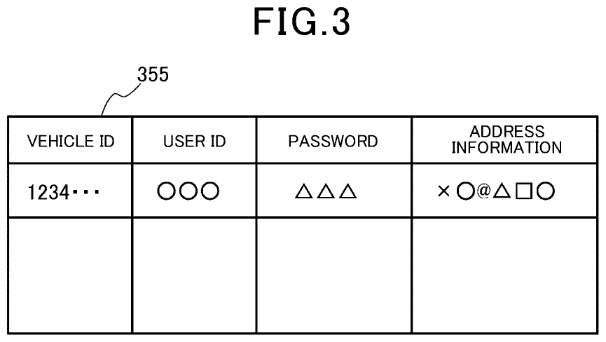

FIG. 3 is a diagram illustrating an example configuration of the user management table 355.

One record in the user management table 355 includes a vehicle ID identifying the vehicle 3, a user ID identifying a user, a password set by the user, and address information of the terminal device 70 carried by the user. The user is the owner of the vehicle 3 having the vehicle ID and the terminal device 70.

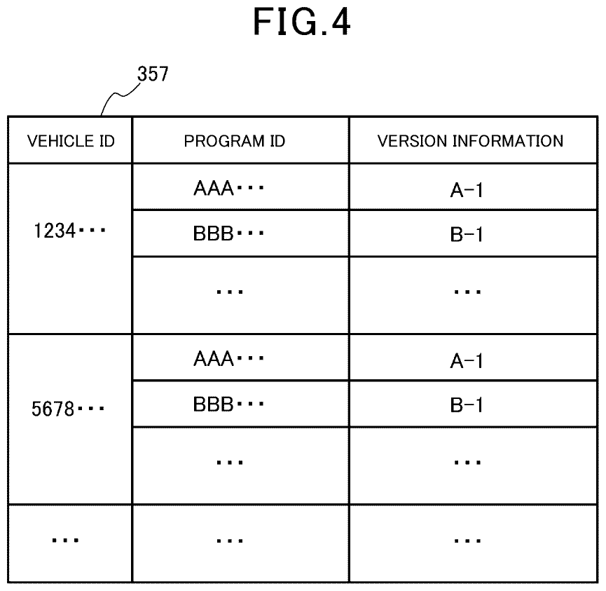

FIG. 4 is a diagram illustrating an example configuration of the program management table 357.

One record in the program management table 357 includes a vehicle ID, a program ID identifying a program, and version information indicating the version of the program. A program ID identifying a program to be executed by an electronic control device installed in the vehicle 3 corresponding to a vehicle ID and the version information of the program already installed on the electronic control device are registered with the program management table 357 in association with the vehicle ID.

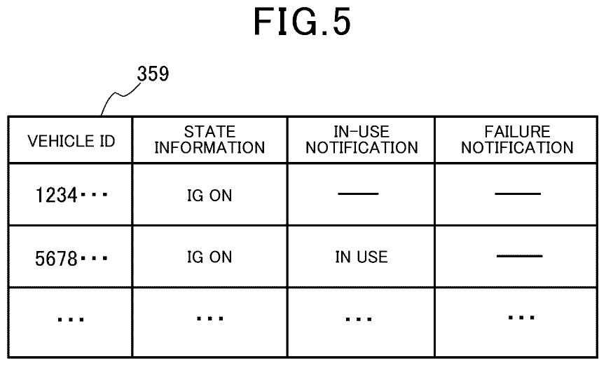

FIG. 5 is a diagram illustrating an example configuration of the vehicle state management table 359.

One record in the vehicle state management table 359 includes a vehicle ID, state information, an in-use notification, and a failure notification.

The vehicle state management table 359 is a table for managing the state of the vehicle 3 having a vehicle ID.

The state information is information indicating the state of the ignition switch, i.e., the starter switch of the vehicle 3 having the vehicle ID, and registers information indicating whether the ignition switch is in the ON state or the OFF state. An ignition switch is hereafter referred to as an IG switch.

The in-use notification is information indicating whether a touch panel 16, i.e., the on-board display device installed in the vehicle 3 is in use or not.

The failure notification is information indicating whether the touch panel 16 is out of order or not.

The first processor 370 is an arithmetic processing unit composed of a Central Processing Unit (CPU) or a Micro Processor Unit (MPU). The first processor 370 may be composed of a single processor or multiple processors.

The first control unit 330 manages the program updates of electronic control devices provided in the vehicle control systems 10 of the vehicles 3 by the first processor 370 executing the control program 351.

When the update program 353 is newly registered with the first storage unit 350, the first control unit 330 obtains the program ID and the version information of the registered update program 353. In reference to the program management table 357, the first control unit 330 obtains the vehicle IDs of vehicles 3 in which programs corresponding to the obtained program ID and older than the version indicated by the version information are installed.

The first control unit 330 sends an update announcement to each of the vehicles 3 having the obtained vehicle IDs, notifying the vehicle 3 of the program update and requesting permission to update the program. The update announcement corresponds to announcement information. However, if the IG switch of the vehicle 3 is not turned on, even if the update announcement is sent to the vehicle control system 10, it will not be displayed on the touch panel 16 of the vehicle 3, nor will it be seen by the occupant.

In addition, if the program update announcement is sent to both the vehicle control system 10 and the occupant's terminal device 70, the vehicle control system 10 and the terminal device 70 may receive different inputs and send different instructions to the server device. In order for the server device 300 to process these different instructions, the process executable by the server device 300 needs to be sophisticated.

The first control unit 330, therefore, determines whether the vehicle 3 is in the active state or not based on whether the IG switch of the vehicle 3 is on or off. If the vehicle 3 is in the active state, i.e., the IG switch is on, the first control unit 330 sends the program update announcement to the vehicle control system 10. If the vehicle 3 is not in the active state, i.e., the IG switch is off, the first control unit 330 sends the program update announcement to the user's terminal device 70.

If the IG switch is off and the program update announcement is sent to the user's terminal device 70 but cannot reach the terminal device 70, the first control unit 330 sends the update announcement to the vehicle control system 10. For example, if the update announcement cannot be sent to the user's terminal device 70 due to the failure of the user's terminal device 70 or a communication failure, the first control unit 330 sends the update announcement to the vehicle control system 10.

When the touch panel 16 is in use, even if the program update announcement is sent to the vehicle control system 10, the update announcement may not be displayed on the touch panel 16. In this case, the first control unit 330 sends the update announcement to the terminal device 70. The touch panel 16 is in use, for example, when video playing back a Digital Versatile Disc (DVD) or the like is being displayed on the touch panel 16.

When the touch panel 16 is out of order, even if the program update announcement is sent to the vehicle control system 10, the update announcement may not be displayed on the touch panel 16. In this case, the first control unit 330 also sends the update announcement to the terminal device 70.

### [3. Configuration of Vehicle Control System]

FIG. 6 is a diagram illustrating a configuration of the vehicle control system 10.

The vehicle control system 10 includes the central ECU 100 having a processor, which is an update control device. The central ECU 100 uses a Telematics Control Unit (TCU) 14 to perform Over The Air (OTA) management. The TCU 14 is a wireless device that complies with a communication standard for mobile communication systems. The OTA management includes control over the process of downloading update programs for electronic control devices provided in the vehicle 3 from the server device 300 and the process of applying downloaded update programs to the electronic control devices.

The central ECU 100 is connected to multiple communication lines including first communication lines 3a and 3b and second communication lines 4a and 4b. The central ECU 100 realizes a gateway function that manages communication data exchange between these communication lines.

The first communication lines 3a and 3b and the second communication lines 4a and 4b are composed of buses for communication compliant with standards such as CAN and Ethernet (R), or communication lines for Peer to Peer (P2P) communication. The first communication lines 3a and 3b may be composed of multiple communication lines that communicate in compliance with the same standard, or may be composed of multiple communication lines that communicate in compliance with different standards. The same is true for the second communication lines 4a and 4b.

An Infotainment Control Box (ICB) 11, a speaker 12, and a microphone 13 are connected to the first communication line 3a via an in-vehicle connection link 19. The Telematics Control Unit (TCU) 14, a Global Navigation Satellite System (GNSS) sensor 15, and the touch panel 16 are also connected to the in-vehicle connection link 19. The touch panel 16 includes a display 17 and a touch sensor 18. The touch panel 16 corresponds to an on-board display device.

The in-vehicle connection link 19 is composed of multiple communication transmission paths compliant with various communication standards. The in-vehicle connection link 19 may include multiple communication networks, for example. In this case, the multiple communication networks may be connected to each other via devices having gateway functions or the like. The in-vehicle connection link 19 may also include a communication network for P2P communication. The communication networks can employ a variety of communication buses that perform network communication in compliance with various standards. Examples of such standards include CAN, Ethernet, Universal Serial Bus (USB), Local Interconnect Network (LIN), and Low Voltage Differential Signaling (LVDS), but other standards may also be used.

The ICB 11 is an In-Vehicle Infotainment (IVI)-ECU. The ICB 11 provides various kinds of information and entertainment to the passengers of the vehicle using the speaker 12, the microphone 13, the GNSS sensor 15, the touch panel 16, and the like.

A Driver Monitoring Camera (DMC) 20 that monitors the driver is connected to the first communication line 3b.

A zone A-ECU 30 is connected to the second communication line 4a. A drive unit 31, a battery 33, and an IG switch 35 are connected to the zone A-ECU 30. The drive unit 31 is, for example, a motor or an internal combustion engine that drives the vehicle 3. The battery 33 provides power to electrical components installed in the vehicle 3. The IG switch 35 is turned on by the occupant in the cabin to start at least one type of drive source, for example, an internal combustion engine or a motor in the vehicle 3. When the IG switch 35 is turned on, the zone A-ECU 30 includes a processor and notifies the central ECU 100 that the IG switch 35 is turned on. When the IG switch 35 is turned off, the zone A-ECU 30 notifies the central ECU 100 that the IG switch 35 is turned off.

A zone B-ECU 40 is connected to the second communication line 4b. Lamps 41, window motors 43, door sensors 45, door lock mechanisms 47, and weight sensors 49 are connected to the zone B-ECU 40.

The lamps 41 may include headlamps, taillamps, and direction indicator lamps, for example. The window motors 43 open and close the vehicle windows. The door sensors 45 detect vehicle door operations. The door lock mechanisms 47 lock and unlock the doors of the vehicle 3. The weight sensors 49 are provided in the seats on which the occupant sits, and detect the weight on the seats. The weight sensors 49 output sensor data indicating the weight on the seats to the zone B-ECU 40. In this embodiment, an example is described in which the weight sensors 49 are provided, but it may be determined whether a person is sitting on the seats or not (left the seats) based on the result of detection by pressure sensors, motion sensors or the like instead of the weight sensors 49. The zone B-ECU 40 outputs sensor data input from the weight sensors 49 to the central ECU 100.

An entry ECU 50 is also connected to the zone B-ECU 40. An LF/RF antenna 51 for wireless communication with a portable device 7 is connected to the entry ECU 50. The portable device 7 is an electronic device having a wireless communication function and is referred to as a smart key or FOB key. The portable device 7 may also be a smartphone that is used as a digital key.

The entry ECU 50 includes a processor performs an authentication process. When the entry ECU 50 receives the key ID of the portable device 7 via the LF/RF antenna 51, the entry ECU 50 determines whether or not the received key ID matches the key ID stored in the entry ECU 50. When the received key ID matches the key ID stored in the entry ECU 50, the entry ECU 50 instructs the zone B-ECU 40 to unlock or lock the door locks. The zone B-ECU 40 includes a processor and instructs the door lock mechanisms 47 to unlock or lock the door locks according to the instructions from the entry ECU 50.

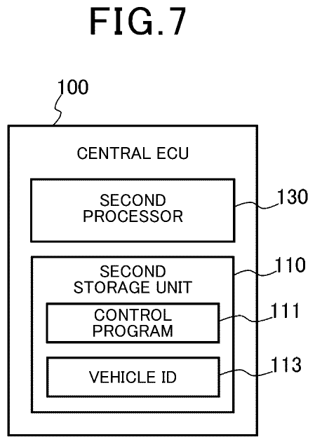

FIG. 7 is a block diagram illustrating a configuration of the central ECU 100.

The central ECU 100 is an electronic control device including a second storage unit 110 and a second processor 130. The second storage unit 110 is composed of a nonvolatile semiconductor memory or volatile and nonvolatile semiconductor memories, for example. The second storage unit 110 stores a control program 111 and a vehicle ID 113. The vehicle ID is identification information that identifies the vehicle 3 equipped with the central ECU 100.

The second processor 130 is an arithmetic processing unit composed of a CPU or MPU. The second processor 130 may be composed of a single processor or multiple processors.

The central ECU 100 obtains, from the zone A-ECU 30, information indicating whether the IG switch is on or off. The central ECU 100 sends state information including the obtained information indicating the state of the IG switch and the vehicle ID to the server device 300 via the TCU 14.

The central ECU 100 also receives an update announcement from the server device 300 via the TCU 14. The central ECU 100 displays the received update announcement on the touch panel 16. When the central ECU 100 receives a permission operation to permit the program update by way of touch operation on the touch panel 16, the central ECU 100 sends permission information indicating the permission of the update to the server device 300. When the central ECU 100 receives a rejection operation not to update the program by way of touch operation on the touch panel 16, the central ECU 100 sends rejection information indicating the rejection of the update to the server device 300. When the server device 300 receives the permission information from the central ECU 100, the server device 300 sends the corresponding update programs to the vehicle 3.

In addition, the central ECU 100 sends, at each predetermined period, version information of programs installed in electronic control devices, such as the zone A-ECU 30 and the zone B-ECU 40, provided in the vehicle control system 10 to the server device 300.

For example, upon receiving the version information of programs from the vehicle 3, the server device 300 determines whether or not there are update programs for those programs, and if there are such update programs, the server device 300 sends an update announcement to the central ECU 100 or the terminal device 70.

When the central ECU 100 detects the occupant getting in the vehicle 3, the central ECU 100 stops transmission of the version information of programs to the server device 300. For example, the central ECU 100 determines whether the occupant has gotten in or gotten out of the vehicle 3 based on sensor data from the weight sensors 49. The central ECU 100 and the weight sensors 49 function as an occupant detection device.

By preventing the central ECU 100 from sending the version information of programs to the server device 300 when the occupant is in the vehicle 3, the server device 300 does not perform processing to determine whether or not there are update programs to be downloaded to the vehicle 3, or the number of times the server device 300 performs processing to determine whether or not there are update programs to be downloaded to the vehicle 3 is reduced. This can reduce the number of times an update announcement is displayed on the terminal device 70. When an update announcement is displayed on a touch panel 73 of the terminal device 70, the occupant in the vehicle may be required to operate the terminal device 70. Thus, it is possible to improve safety by reducing the number of times an update announcement is displayed on the terminal device 70 while the occupant is in the vehicle 3.

The central ECU 100 also sends an in-use notification to the server device 300 indicating whether the touch panel 16 is in use or not. For example, the central ECU 100 sends an in-use notification to the server device 300 indicating that the touch panel 16 is in use when video playing back a DVD under the control of another electronic control device or the like is being displayed on the touch panel 16. When the display on the touch panel 16 by another electronic control device is finished, the central ECU 100 may send a termination notification indicating that the use of the touch panel 16 is finished. The central ECU 100 determines whether the touch panel 16 is in use or not depending on whether a notification is received from another electronic control device or not. The central ECU 100 functions as a usage detection unit.

The central ECU 100 also sends a failure notification to the server device 300 when a failure of the touch panel 16 is detected.

For example, the touch panel 16 is equipped with an illuminance sensor that detects the brightness of the screen of the touch panel 16 and an RGB sensor that detects the degree of brightness of each of the red (R), green (G), and blue (B) colors displayed on the touch panel 16. If the central ECU 100 determines that the touch panel 16 is out of order based on sensor data from these sensors, the central ECU 100 sends a failure notification to the server device 300. The illuminance sensor, the RGB sensor, and the central ECU 100 function as a failure detection unit.

If the IG switch 35 is turned off while an update announcement is being displayed on the touch panel 16 and therefore an operation indicating whether or not to permit updating to the update programs cannot be received, the central ECU 100 may send a notification of that effect to the server device 300. In response to receiving this notification, the server device 300 can send the update announcement to the user's terminal device 70.

If the IG switch 35 is turned off while an update announcement is being displayed on the touch panel 16, but the occupant does not get out of the vehicle 3, the central ECU 100 may continue to display the update announcement on the touch panel 16. If the occupant turns off the IG switch 35 but does not get out of the vehicle 3, the occupant may be spending time in the vehicle 3 for taking a break from driving or the like. Thus, the central ECU 100 does not clear the update announcement displayed on the touch panel 16 but continues to display the update announcement on the touch panel 16. This can increase the possibility of receiving a permission operation from the occupant to permit the program update. The central ECU 100 clears the update announcement displayed on the touch panel 16 when the weight sensors 49 detect the occupant getting out of the vehicle 3.

### [4. Configuration of Terminal Device]

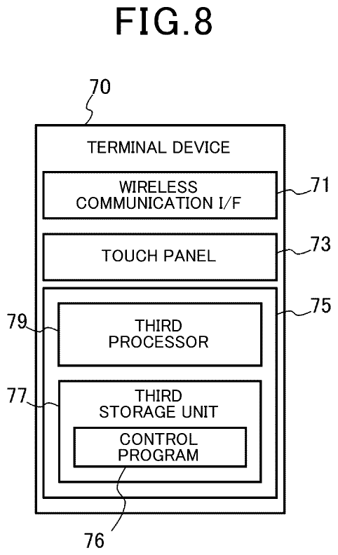

FIG. 8 is a block diagram illustrating a configuration of the terminal device 70.

The terminal device 70 carried by a user will now be explained.

The terminal device 70 includes a wireless communication I/F 71, the touch panel 73, and a third control unit 75.

The wireless communication I/F 71 is a wireless communication device including an antenna, a Radio Frequency (RF) circuit, a baseband circuit, an encoder, and a decoder, and is connected to the communication network 5 including a mobile communication network.

The touch panel 73 is equipped with a display panel, such as a liquid crystal panel or organic EL panel, and a touch sensor to detect touch operations. The touch panel 73 corresponds to a display unit.

The third control unit 75 is a computer device including a third storage unit 77 and a third processor 79.

The third storage unit 77 includes a semiconductor memory such as a ROM or a RAM, and stores a control program 76 executed by the third processor 79.

The third processor 79 is an arithmetic processing unit composed of a CPU or MPU. The third processor 79 may be composed of a single processor or multiple processors.

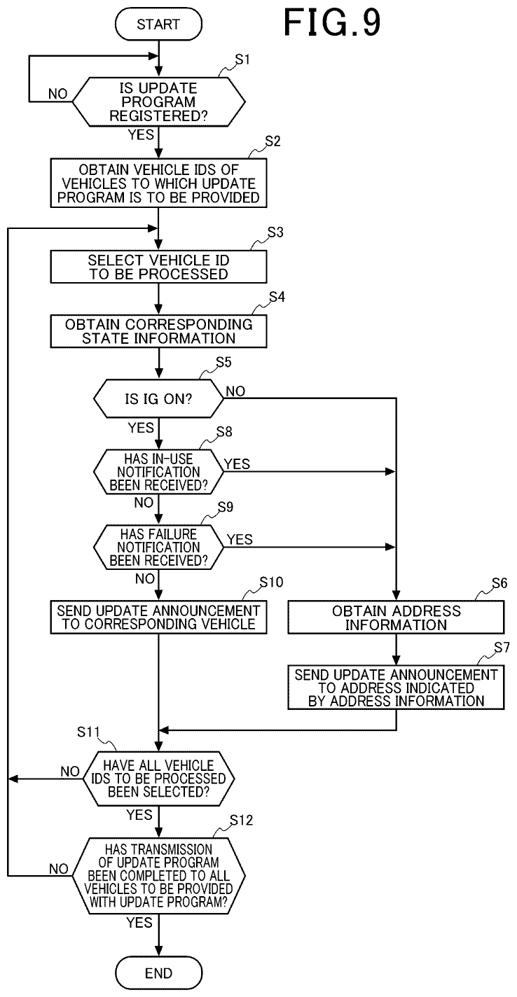

FIG. 9 is a flowchart illustrating the operation of the server device 300.

The operation of the server device 300 is described with reference to the flowchart shown in FIG. 9.

First, the first control unit 330 determines whether or not the update program 353 is registered with the first storage unit 350 (step S1). If no update program 353 is registered with the first storage 350 (step S1/NO), the first control unit 330 waits until the update program 353 is registered with the first storage 350.

If the update program 353 is registered with the first storage unit 350 (step S1/YES), the first control unit 330 obtains the vehicle IDs of vehicles 3 to which the registered update program 353 is to be provided (step S2).

The first control unit 330 obtains the program ID and the version information of the registered update program 353. The first control unit 330 obtains the vehicle IDs of vehicles 3 that use programs having the obtained program ID and older than the version indicated by the version information from the program management table 357 shown in FIG. 4.

Next, the first control unit 330 obtains one vehicle ID to be processed from the vehicle IDs obtained in step S2 (step S3). The first control unit 330 obtains the state information of the vehicle 3 having the obtained vehicle ID with reference to the vehicle state management table 359 (step S4).

The first control unit 330 determines whether the IG switch of the vehicle 3 is on or not based on the obtained state information (step S5). If the IG switch is off (step S5/NO), the first control unit 330 obtains address information with reference to the user management table 355 (step S6). The first control unit 330 sends an update announcement to the address indicated by the obtained address information (step S7).

The operation in the case where the IG switch of the vehicle 3 to be processed is on in step S5 is now described.

If the IG switch of the vehicle 3 to be processed is on (step S5/YES), the first control unit 330 determines whether the touch panel 16 of the vehicle 3 is in use or not with reference to the vehicle state management table 359 (step S8). The first control unit 330 determines whether or not the vehicle 3 is registered as “in use” in the record corresponding to the vehicle ID in the vehicle state management table 359.

If the touch panel 16 of the vehicle 3 is in use (step S8/YES), the first control unit 330 obtains address information with reference to the user management table 355 (step S6). The first control unit 330 sends an update announcement to the address indicated by the obtained address information (step S7).

If the touch panel 16 of the vehicle 3 is not in use (step S8/NO), the first control unit 330 determines whether the touch panel 16 of the vehicle 3 is out of order or not with reference to the vehicle state management table 359 (step 9). The first control unit 330 determines whether or not the vehicle 3 is registered as “out of order” in the record corresponding to the vehicle ID in the vehicle state management table 359.

If the touch panel 16 of the vehicle 3 is out of order (step S9/YES), the first control unit 330 obtains address information with reference to the user management table 355 (step S6). The first control unit 330 sends an update announcement to the address indicated by the obtained address information (step S7).

If the touch panel 16 of the vehicle 3 is not out of order (step S9/NO), the first control unit 330 sends an update announcement to the vehicle 3 having the vehicle ID to be processed (step S10).

After executing processing in step S7 or step S10, the first control unit 330 determines whether or not all the vehicle IDs obtained in step S2 have been selected as process IDs to be processed (step S11). If all the vehicle IDs have not been selected as process IDs to be processed (step S11/NO), the first control unit 330 returns to step S3 and again selects another vehicle ID to be processed (step S3).

If all the vehicle IDs have been selected as process IDs to be processed (step S11/YES), the first control unit 330 determines whether or not the transmission of the update program has been completed to all the vehicles 3 having the vehicle IDs obtained in step S2 (step S12). If the transmission of the update program has not been completed to all the vehicles 3 (step S12/NO), the first control unit 330 returns to step S3 and again selects another vehicle ID to be processed (step S3). If the transmission of the update program has been completed to all the vehicles 3 (step S12/YES), the first control unit 330 terminates this process flow.

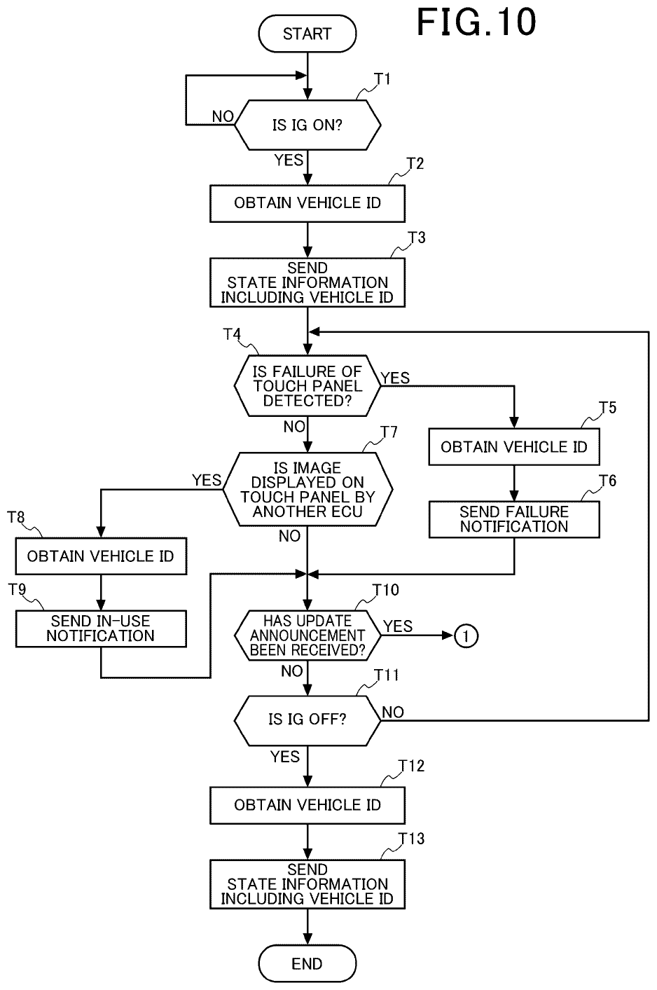

FIG. 10 is a flowchart illustrating the operation of the central ECU 100.

The operation of the central ECU 100 is described with reference to the flowchart shown in FIG. 10.

The central ECU 100 determines whether the IG switch is on or not (step T1). The central ECU 100 determines whether the IG switch is on or not by determining whether an IG switch on notification is input from the zone A-ECU 30 or not.

If the IG switch is not turned on (step T1/NO), the central ECU 100 waits until an IG switch on notification is input from the zone A-ECU 30.

If the IG switch is turned on (step T1/YES), the central ECU 100 obtains the vehicle ID from the first storage unit 350 (step S2). The central ECU 100 sends state information including the obtained vehicle ID and information indicating that the IG switch is on to the server device 300 (step T3).

Then, the central ECU 100 performs failure detection for the touch panel 16. The central ECU 100 determines whether the touch panel 16 is out of order or not based on sensor data from the illuminance sensor and the RGB sensor (step T4).

If the touch panel 16 is out of order (step T4/YES), the central ECU 100 obtains the vehicle ID from the first storage unit 350 (step S5). The central ECU 100 sends a failure notification including the obtained vehicle ID and information indicating that the touch panel 16 is out of order to the server device 300 (step T6).

If the touch panel 16 is not out of order (step T4/NO), the central ECU 100 determines whether or not an image is being displayed on the touch panel 16 by another ECU (step T7). If an image is being displayed on the touch panel 16 by another ECU (step T7/YES), the central ECU 100 obtains the vehicle ID from the first storage unit 350 (step T8). The central ECU 100 sends an in-use notification including the obtained vehicle ID and information indicating that the touch panel 16 is in use to the server device 300 (step T9).

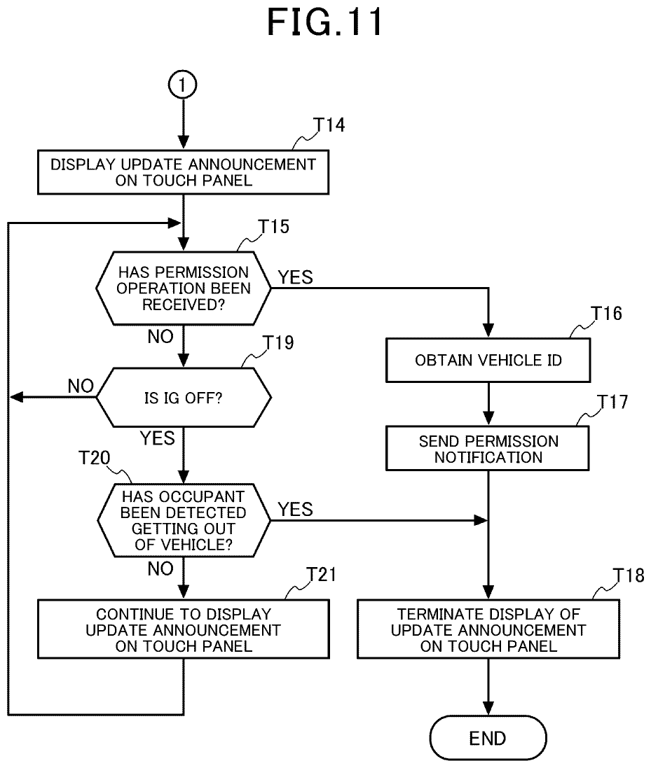

If the central ECU 100 determines that an image is not being displayed on the touch panel 16 in step T7, the central ECU 100 determines whether or not it has received an update announcement from the server device 300 after performing processing in step T6 or step T9 (step T10). The operation in the case where the central ECU 100 has received an update announcement is described with reference to the flowchart shown in FIG. 11.

If the central ECU 100 has not received an update announcement from the server device 300 (step T10/NO), the central ECU 100 determines whether the IG switch is off or not (step T11). The central ECU 100 determines whether the IG switch is off or not by determining whether an IG switch off notification is input from the zone A-ECU 30 or not.

If the IG switch is not off (step T11/NO), the central ECU 100 returns to the determination in step T4. If the IG switch is turned off (step T11/YES), the central ECU 100 obtains the vehicle ID from the first storage unit 350 (step S12). The central ECU 100 sends state information including the obtained vehicle ID and information indicating that the IG switch is off to the server device 300 (step T13) and terminates the process.

FIG. 11 is a flowchart illustrating the operation of the central ECU 100 if it has received an update announcement from the server device 300.

The operation of the central ECU 100 is described with reference to the flowchart shown in FIG. 11.

If the central ECU 100 has received an update announcement from the server device 300 (step T10/YES), the central ECU 100 displays the received update announcement on the touch panel 16 (step T14).

Then, the central ECU 100 determines whether or not it has received a permission operation to permit the program update (step T15).

If the central ECU 100 has received a permission operation by way of touch operation on the touch panel 16 (step T15/YES), the central ECU 100 obtains the vehicle ID from the first storage unit 350 (step T16). The central ECU 100 sends a permission notification including the obtained vehicle ID and information indicating that the program update is permitted to the server device 300 (step T17).

After that, the central ECU 100 terminates display of the update announcement on the touch panel 16 (step T18).

If the central ECU 100 has not received a permission operation (step T15/NO), the central ECU 100 determines whether the IG switch is off or not (step T19). The central ECU 100 determines whether the IG switch is off or not by determining whether an IG switch off notification is input from the zone A-ECU 30 or not.

If the IG switch is not off (step T19/NO), the central ECU 100 returns to the determination in step T15.

If the IG switch is turned off (step T19/YES), the central ECU 100 determines whether or not the occupant has been detected getting out of the vehicle 3 (step T20). The central ECU 100 determines whether or not the occupant has gotten out of the vehicle 3 based on sensor data from the weight sensors 49.

If the occupant has not been detected getting out of the vehicle 3 (step T20/NO), the central ECU 100 continues to display the update announcement on the touch panel 16 (step T21). If the occupant has been detected getting out of the vehicle 3 (step T20/YES), the central ECU 100 terminates display of the update announcement on the touch panel 16 (step T18).

The embodiment described above is a preferable embodiment of the present invention. However, this invention is not limited to this embodiment, and various variations can be made without departing from the scope of the gist of the invention.

Each functional unit of the server device 300 shown in FIG. 2, the vehicle control system 10 shown in FIG. 6, and the central ECU 100 shown in FIG. 7 merely illustrates a functional configuration, and specific implementations are not limited. That is, it is not necessary to implement hardware for each corresponding functional unit separately, but it is obviously possible to configure a single processor to realize the functions of multiple functional units by executing programs. Some of the functions realized in software in the above embodiment may be realized in hardware, or some of the functions realized in hardware may be realized in software.

The processing units in the flowchart shown in FIG. 9 are divided according to the main processing features in order to facilitate understanding of the process executed by the server device 300, and the present invention is not limited by the division and the names of the processing units shown in the flowchart in FIG. 9. The process executed by the server device 300 can be divided into a greater number of processing units, or can be divided so that each processing unit includes more processing, according to the processing features. The order of processing in the above flowchart is also not limited to the example shown in the figure. The same is true for the central ECU 100 shown in FIGS. 10 and 11.

### [5. Configurations Supported by Above Embodiment]

The above embodiment is a specific example of the following configurations.

### (Configuration 1)

A program update system, including: a server device configured to provide an update program to be executed by an electronic control device installed in a vehicle; an update control device installed in the vehicle and configured to cause a program executed by the electronic control device to be updated to the update program; and a terminal device carried by an occupant of the vehicle, wherein the server device is configured to be able to send announcement information inquiring whether or not to permit updating to the update program to the update control device and the terminal device, and to obtain state information indicating a state of a starter switch that starts the vehicle from the vehicle and to send the announcement information to one of the update control device and the terminal device based on the state information, the update control device is configured to display the announcement information on an on-board display device provided in the vehicle if the update control device receives the announcement information, and the terminal device is configured to display the announcement information on a display unit of the terminal device if the terminal device receives the announcement information.

In the program update system in configuration 1, announcement information inquiring whether or not to permit updating to an update program is sent to one of the update control device and the terminal device based on state information indicating the state of the starter switch of the vehicle. This prevents the announcement information from being displayed on both the on-board display device and the terminal device.

If the announcement information is displayed on both the on-board display device and the terminal device, operations may be accepted by both the terminal device and the update control device, in which case, different information may be input to the server device from the terminal device and the update control device, and to deal with such a situation, the process executed by the server device needs to be more sophisticated, which may increase the cost for the server device. Thus, preventing the announcement information from being displayed on both the on-board display device and the terminal device can avoid complicating the process executed by the server device.

### (Configuration 2)

The program update system according to configuration 1, wherein the update control device is configured to send the state information indicating that the starter switch is on to the server device when the starter switch is turned on, and the server device is configured to send the announcement information to the update control device but not to the terminal device when the server device receives the state information.

In the program update system in configuration 2, when the occupant is detected getting in the vehicle by an occupant detection device, the server device is notified that the occupant has gotten in the vehicle, and when the server device receives this notification, the server device does not send the announcement information to the terminal device.

This can prevent the transmission of announcement information to the terminal device while the occupant is in the vehicle, thereby preventing the occupant from operating the terminal device while driving.

### (Configuration 3)

The program update system according to configuration 2, wherein the vehicle includes an occupant detection device to detect the occupant getting in the vehicle, and the update control device is configured to prohibit transmission of version information of the program installed in the electronic control device to the server device when the occupant detection device detects the occupant getting in the vehicle.

In the program update system in configuration 3, the update control device prohibits transmission of the version information of the program to the server device when the occupant is detected getting in the vehicle. This can prevent the server device from obtaining the version information of the program installed in the electronic control device, and thus can prevent the update announcement from being sent to the terminal device.

### (Configuration 4)

The program update system according to configuration 2 or 3, wherein if the on-board display device is in a predetermined state, the update control device is configured to send a notification to the server device that the on-board display device is unable to display the announcement information, and when the server device receives the notification, the server device is configured to send the announcement information to the terminal device even when the starter switch is on.

In the program update system in configuration 4, the server device sends the announcement information to the terminal device if the on-board display device is in a predetermined state. This allows the terminal device to display the announcement information if the on-board display device is in the predetermined state.

### (Configuration 5)

The program update system according to configuration 4, wherein the update control device includes a usage detection unit to detect usage of the on-board display device, and the predetermined state includes a state in which usage of the on-board display device is detected by the usage detection unit.

In the program update system in configuration 5, the announcement information is sent by the server device to the terminal device when the usage of the on-board display device is detected. This allows the terminal device to display the announcement information if the on-board display device is in use.

### (Configuration 6)

The program update system according to configuration 4, wherein the update control device includes a failure detection unit to detect a failure of the on-board display device, and the predetermined state includes a state in which a failure of the on-board display device is detected by the failure detection unit.

In the program update system in configuration 6, the announcement information is sent by the server device to the terminal device when a failure of the on-board display device is detected. This allows the terminal device to display the announcement information if the on-board display device is unable to display the announcement information.

### (Configuration 7)

The program update system according to configuration 1, wherein if the update control device is unable to receive an operation indicating whether or not to permit updating to the update program before an end of display of the announcement information displayed on the on-board display device, the update control device is configured to send a notification to the server device that the update control device has failed to receive the operation indicating whether or not to permit updating.

In the program update system in configuration 7, if an operation indicating whether or not to permit updating to the update program cannot be received, a notification that the operation indicating whether or not to permit updating has failed to be received is sent to the server device. This can cause the server device to perform processing such as sending the announcement information to the terminal device.

### (Configuration 8)

The program update system according to configuration 2, wherein the update control device is configured to send the state information indicating that the starter switch is off to the server device when the starter switch is turned off, and the server device is configured to send the announcement information to the terminal device when the server device receives the state information indicating that the starter switch is off.

In the program update system in configuration 8, the announcement information is sent to the update control device if the announcement information cannot be sent to the terminal device. By displaying the announcement information on the on-board display device, the update control device can prompt the occupant to input an operation indicating whether or not to permit updating to the update program.

### (Configuration 9)

The program update system according to configuration 8, wherein the server device is configured to send the announcement information to the update control device if the server device is unable to send the announcement information to the terminal device.

In the program update system in configuration 9, the announcement information is sent to the update control device if the announcement information cannot be sent to the terminal device. This allows the announcement information to be sent to the update control device and displayed on the on-board display device even when the starter switch is off if the announcement information cannot be sent to the terminal device.

### (Configuration 10)

The program update system according to configuration 6, wherein the vehicle includes an occupant detection device to detect the occupant getting in the vehicle, and the update control device is configured to continue to display the announcement information on the on-board display device if the starter switch is turned off but the occupant detection device determines that the occupant stays in the vehicle.

In the program update system in configuration 10, the announcement information continues to be displayed on the on-board display device if the starter switch is turned off but the occupant detection device determines that the occupant stays in the vehicle. This allows the occupant to input an operation indicating whether or not to permit updating to the update program.

### (Configuration 11)

A display control method in a program update system including a server device configured to provide an update program to be executed by an electronic control device installed in a vehicle, an update control device installed in the vehicle and configured to cause a program executed by the electronic control device to be updated to the update program, and a terminal device carried by an occupant of the vehicle, the method including the server device being configured to be able to send announcement information inquiring whether or not to permit updating to the update program to the update control device and the terminal device, obtaining state information indicating a state of a starter switch that starts the vehicle from the vehicle, and sending the announcement information to one of the update control device and the terminal device based on the state information; the update control device displaying the announcement information on an on-board display device provided in the vehicle if the update control device receives the announcement information; and the terminal device displaying the announcement information on a display unit of the terminal device if the terminal device receives the announcement information.

In the control method in the program update system in configuration 11, announcement information inquiring whether or not to permit updating to an update program is sent to one of the update control device and the terminal device based on state information indicating the state of the starter switch of the vehicle. This can prevent the announcement information from being displayed on both the on-board display device and the terminal device. If the announcement information is displayed on both the on-board display device and the terminal device, operations may be accepted by both the terminal device and the update control device, in which case, different information may be input to the server device from the terminal device and the update control device, and to deal with such a situation, the process executed by the server device needs to be more sophisticated, which may increase the cost for the server device. Thus, preventing the announcement information from being displayed on both the on-board display device and the terminal device can avoid complicating the process executed by the server device.
1 . . . program update system, 3 . . . vehicle, 3a . . . first communication line, 3b . . . first communication line, 4a . . . second communication line, 4b . . . second communication line, 5 . . . communication network, 7 . . . portable device, 10 . . . vehicle control system, 11 . . . ICB, 12 . . . speaker, 13 . . . microphone, 14 . . . TCU, 15 . . . GNSS sensor, 16 . . . touch panel, 17 . . . display, 18 . . . touch sensor, 19 . . . in-vehicle connection link, 20 . . . DMC, 30 . . . zone A-ECU, 31 . . . drive unit, 33 . . . battery, 35 . . . power switch, 40 . . . zone B-ECU, 41 . . . lamp, 43 . . . window motor, 45 . . . door sensor, 47 . . . door lock mechanism, 49 . . . weight sensor, 50 . . . entry ECU, 51 . . . LF/RF antenna, 70 . . . terminal device, 71 . . . wireless communication I/F, 73 . . . touch panel, 75 . . . third control unit, 76 . . . control program, 77 . . . third storage unit, 79 . . . third processor, 100 . . . central ECU, 110 . . . second storage unit, 111 . . . control program, 113 . . . vehicle ID, 130 . . . second processor, 300 . . . server device, 310 . . . communication I/F, 330 . . . first control unit, 350 . . . first storage unit, 351 . . . control program, 353 . . . update program, 355 . . . user management table, 357 . . . program management table, 359 . . . vehicle state management table, 370 . . . first processor.

1. A program update system, comprising: a server device configured to provide an update program to be executed by an electronic control device installed in a vehicle; an update control device installed in the vehicle and configured to cause a program executed by the electronic control device to be updated to the update program; and a terminal device carried by an occupant of the vehicle, wherein
the server device is configured to be able to send announcement information inquiring whether or not to permit updating to the update program to the update control device and the terminal device, and to obtain state information indicating a state of a starter switch that starts the vehicle from the vehicle and to send the announcement information to one of the update control device and the terminal device based on the state information,
the update control device is configured to display the announcement information on an on-board display device provided in the vehicle if the update control device receives the announcement information, and
the terminal device is configured to display the announcement information on a display unit of the terminal device if the terminal device receives the announcement information.

2. The program update system according to claim 1, wherein
the update control device is configured to send the state information indicating that the starter switch is on to the server device when the starter switch is turned on, and
the server device is configured to send the announcement information to the update control device but not to the terminal device when the server device receives the state information.

3. The program update system according to claim 2, wherein
the vehicle includes an occupant detection device to detect the occupant getting in the vehicle, and
the update control device is configured to prohibit transmission of version information of the program installed in the electronic control device to the server device when the occupant detection device detects the occupant getting in the vehicle.

4. The program update system according to claim 2, wherein
if the on-board display device is in a predetermined state, the update control device is configured to send a notification to the server device that the on-board display device is unable to display the announcement information, and
when the server device receives the notification, the server device is configured to send the announcement information to the terminal device even when the starter switch is on.

5. The program update system according to claim 4, wherein
the update control device includes a usage detection unit to detect usage of the on-board display device, and
the predetermined state includes a state in which usage of the on-board display device is detected by the usage detection unit.

6. The program update system according to claim 4, wherein
the update control device includes a failure detection unit to detect a failure of the on-board display device, and
the predetermined state includes a state in which a failure of the on-board display device is detected by the failure detection unit.

7. The program update system according to claim 1, wherein if the update control device is unable to receive an operation indicating whether or not to permit updating to the update program before an end of display of the announcement information displayed on the on-board display device, the update control device is configured to send a notification to the server device that the update control device has failed to receive the operation indicating whether or not to permit updating.

8. The program update system according to claim 2, wherein
the update control device is configured to send the state information indicating that the starter switch is off to the server device when the starter switch is turned off, and
the server device is configured to send the announcement information to the terminal device when the server device receives the state information indicating that the starter switch is off.

9. The program update system according to claim 8, wherein
the server device is configured to send the announcement information to the update control device if the server device is unable to send the announcement information to the terminal device.

10. The program update system according to claim 8, wherein
the vehicle includes an occupant detection device to detect the occupant getting in the vehicle, and
the update control device is configured to continue to display the announcement information on the on-board display device if the starter switch is turned off but the occupant detection device determines that the occupant stays in the vehicle.

11. A display control method in a program update system including a server device configured to provide an update program to be executed by an electronic control device installed in a vehicle, an update control device installed in the vehicle and configured to cause a program executed by the electronic control device to be updated to the update program, and a terminal device carried by an occupant of the vehicle, the method comprising:
the server device being configured to be able to send announcement information inquiring whether or not to permit updating to the update program to the update control device and the terminal device, obtaining state information indicating a state of a starter switch that starts the vehicle from the vehicle, and sending the announcement information to one of the update control device and the terminal device based on the state information;
the update control device displaying the announcement information on an on-board display device provided in the vehicle if the update control device receives the announcement information; and
the terminal device displaying the announcement information on a display unit of the terminal device if the terminal device receives the announcement information.
